(19) United States
(12) Patent Application Publication
(10) Pub. No.: US 2003/0100233 A1
(43) Pub. Date: May 29, 2003

(54) Industrial roofing fabric and membrane

(76) Inventors: Roger T. Fynan, LaGrange, GA (US); Philbrick Allen, Simpsonville, SC (US); Brian Callaway, Moore, SC (US); John L. McMurray, Clinton, SC (US)

Correspondence Address: MILLIKEN & COMPANY, 920 MILLIKEN RD, PO BOX 1926, SPARTANBURG, SC, 29304, US

(21) Appl. No.: 10/004,252

(22) Filed: Nov. 1, 2001

(51) Int. Cl. B32B 27/12; B32B 23/02; B32B 3/04; B32B 5/12; B32B 5/02; B32B 27/04; D04H 5/02; D04H 3/00

(52) U.S. Cl. 442/58; 442/1; 442/43; 442/50; 428/121; 428/130; 428/192

(57) ABSTRACT

Roofing membrane comprises reinforcing scrim fabric and a polymeric material, such as EPDM or TPO. The fabric is preferably a polyester tri-directional laid scrim fabric made from continuous yarns, which is held together by an adhesive, such as polyvinyl alcohol (PVOH) or styrene butadiene rubber (SBR), or any other suitable adhesive such as plastisol polyvinyl chloride. The polyester scrim fabric includes a central area and selvage areas on opposing edges thereof. The selvage areas of the fabric include more strands of yam than the central area, to provide additional strength along the sides of the fabric. Further, the continuous yarns that make up the selvage are not cut along the edges, so that the continuous yarns form loops along the edge portions of the selvage areas.

### BACKGROUND OF THE INVENTION

This invention relates to a new and improved roofing fabric and membrane that incorporates a novel substrate that allows the roofing fabric to be securely positioned on a roof and which is very flexible for mounting but has sufficient strength to provide the necessary service life for use as industrial roofing. In the manufacturing of industrial roofing material for flat roofs, it is desirable to have a thin, flexible material which can be easily rolled out and tacked down and which will provide the desired protection for a number of years without tearing and/or rotting. Various states and organizations have enacted building code provisions that the roofing material must meet or exceed before it can be used for industrial roofs. The fabric disclosed and claimed herein conforms to the necessary codes of the various organizations and states.

Heretofore, it has been difficult to produce an industrial roofing membrane that was thin and flexible enough to facilitate transport and installation, durable enough to withstand severe weather conditions for an extended period of time, and strong enough to remain securely fastened to the roof under severe adverse wind and rain conditions.

Prior attempts to produce such an industrial roofing membrane have met with limited success, at best. U.S. Pat. Nos. 5,540,971 and 5,525,413, both disclose a triaxially wound non woven roofing membrane fabric, where the selvage areas of the fabric have an increased number of warp yarns in spaced groups to provide an area for the attachment of the fabric to a roof through the use of roofing tacks inserted through the selvage areas of the fabric. However, roofing membrane fabric produced in accordance with those patents may not perform as well as may be desired in high wind situations, partially because the weft ends of those products are cut to size, so that the weft yarns are non-continuous throughout the fabric. U.S. Pat. No. 6,094,883 discloses a vapor barrier.

All patents referenced herein are incorporated by reference in their entirety.

Therefore, it would be desirable to manufacture a lightweight, flexible roofing fabric and roofing membrane that is durable and exhibits superior strength characteristics to reduce likelihood of tearing or becoming unsecured from a roof during severe weather and high winds.

### OBJECTS OF THE INVENTION

Accordingly, it is an object of the present invention to provide a roofing fabric that includes a reinforced selvage portion and continuous loop-forming yarns along the edges of the selvage portions to provide increased strength for securing the fabric to a roof.

Another object of the present invention is to provide a single ply roofing membrane comprising a lightweight non-woven scrim fabric in combination with a polymer such as EPDM, PVC, TPO, TPE or a modified bitumen to form a flexible, lightweight, and strong alternative to prior roofing membranes.

Yet another object of the present invention is to provide a single ply roofing membrane that exhibits superior performance in high wind conditions.

It is another object of the present invention to provide a single ply roofing fabric that eliminates the need for a heat sealed selvage, which is typically required to prevent the unraveling of warp ends during coating and laminating.

Still another object of the present invention is to provide a single ply roofing membrane that is economical to manufacture, and which overcomes some of the problems commonly associated with prior roofing membranes.

### BRIEF DESCRIPTION OF THE DRAWINGS

These and other features, aspects, and advantages of the present invention will become better understood with regard to the following description, appended claims, and accompanying drawings where:

FIG. 1 is a top view of the scrim fabric substrate used in the roofing material; and

FIG. 2 is a cross-sectional view of the scrim fabric substrate in combination with the polymeric material, which forms the roofing membrane.

### DETAILED DESCRIPTION

The new and improved roofing membrane 10 essentially consists of the fabric 12 and a polymeric material 14, such as ethylenepropylenediene (EPDM) or thermoplastic olefin (TPO). The fabric 12 is preferably a polyester tri-directional laid scrim fabric made from continuous yarns 20, which is held together by an adhesive, such as polyvinyl alcohol (PVOH), acrylic, acrylic latex or styrene butadiene rubber (SBR), or any other suitable adhesive such as plastisol polyvinyl chloride. The polyester scrim fabric 12, in a preferred embodiment, includes a central area 16 and selvage areas 18 on opposing edges thereof. As used herein, the term “scrim” shall mean a fabric having an open construction used as a base fabric or a reinforcing fabric. Also, as used herein, the term “continuous yarn” shall mean a yarn that is uncut, or which is unsegmented. The term “continuous yarn” should not be confused with a continuous filament yarn, which comprises continuous filaments as opposed to staple fibers or tow fibers.

The selvage areas 18 of the fabric 12 include more strands of yarn than the central area 16, to provide additional strength along the sides of the fabric 12. Further, the continuous yarns 20 that make up the selvage are not cut along the edges, so that the continuous yarns form loops 22 along the edge portions of the selvage areas 18.

Heretofore, tri-directional scrim has been used within certain industrial roofing membrane applications as a reinforcement material, but the scrim has traditionally been cut along the edges, so that the continuous yarns in the weft direction were cut at each edge of the scrim. One problem associated with cutting the selvage along the edges is that when a fastening device (such as roofing tack, screw, etc.) is used to attach the roofing membrane to a roof, a high wind tends to tear the membrane and forcibly remove it from the roof. It has been found that by leaving the edges of the selvage uncut, thereby allowing the continuous weft yarns to remain intact in the form of loops along the edges, the strength of the membrane that is imparted by the scrim fabric is significantly increased. The resulting effect is that the selvage portion of the roofing fabric is much less likely to tear away from a fastening device, and the roofing membrane remains secured to a roof in significantly higher winds.

A wind test was performed, as described in Example I.

### EXAMPLE I

The wind test was performed in accordance with the FMRC (Factory Mutual Research Corporation) 12×24 Uplift Pressure Test Procedure number 4470. The test measures the performance of roof covers and assemblies to resist wind uplift forces on building roofs. The test consists of an open-top rectangular steel pressure vessel approximately 2 inches deep to accommodate the horizontal test specimen frame upon which the roof sample is constructed. The test specimen frame, containing the finished roof, is placed on the pressure vessel and is sealed by a foam polyurethane gasket located between the top of the pressure vessel and the bottom of the test specimen frame. Contact between the pressure vessel and the test specimen frame is made at the perimeter and at three intermediate support clips that are located near the centerline of the pressure vessel running parallel to the 24-foot dimension and spaced at approximately 6 feet.

Air is supplied to the vessel in increasing amounts to maintain a certain pressure for a given length of time on the underside of the roof and to offset minor pressure loss due to leaks. The sustained air pressure delivered to the underside of the roof represents the combined positive and negative pressures exerted on an actual roof from above and below. Air is introduced beneath the sample in accordance with the pressure schedule noted below. For each test, the sample is maintained at each level of pressure for a period of one minute until the test is terminated or until failure occurs, with 15 psi increments added for each successive minute.

Pressure (psi)
30
45
60
75
90
105
etc.

Average wind velocities can vary considerably from area to area. These wind velocities in miles per hour are related to the velocity pressure in lb/ft². For a detailed explanation of these forces, see the current edition of Factory Mutual Engineering & Research Data Sheet I-7, “Wind Forces on Buildings and Other Structures.”

To qualify for Class I-60 Windstorm Classification, the assembly must withstand the effect of a minimum of 60 psi uplift pressure for a duration of 1 full minute. Likewise for Class I-90 Windstorm Classification, the assembly must withstand the effect of a minimum of 90 psi uplift pressure for a duration of 1 full minute, and so on. Prior to and during attainment of these pressures, the roof assembly is carefully observed for the presence of bowing, cracking, delamination, separation of adhered areas, removal or fracture of fasteners, etc. After test termination or failure, the assembly is dismantled and examined to determine the mode of failure.

| | Membrane | Deck | | Attachment | Membrane | |
|---|---|---|---|---|---|---|
| Fabric Type | Type | Type | Fastener | Spacing | Width | Uplift result |
| Weft | 0.045 mil | Steel, 22 | Fastener | 6″ on center | 10′ | Rated @ I- |
| insertion 9 × 9 | EPDM | ga | with polymer | | | 105 max |
| 1000d | rubber | | plate | | | |
| experimental | 0.045 mil | Steel, 22 | Fastener | 6″ on center | 10′ | Passed @ I- |
| 9 × 4 × 4 | EPDM | ga | with polymer | | | 135 for 1 |
| reinforced | rubber | | plate | | | min |
| edges | | | | | | |
| experimental | 0.045 mil | Steel, 22 | Fastener | 12″ on center | 10′ | Passed @ I- |
| 9 × 4 × 4 | EPDM | ga | with polymer | | | 75 for 1 min. |
| reinforced | rubber | | plate | | | |
| edges | | | | | | |

Specifically, in a preferred embodiment, the fabric 12 is composed of fully drawn high tenacity (4 grams or greater/denier) polyester continuous filament yarns, but other yarns such as nylon, fiberglass or combinations thereof may be used if desired. One particularly useful alternate embodiment involves using two ends of an aramid fiber in ST warp with one end being approximately 3 inches from the edge of the fabric, and a second end being approximately 3.5 inches from the edge of the fabric. This arrangement, when applied to both longitudinal sides of the fabric within the selvage portion, allows the fasteners to be placed between the two ends of the aramid fibers in order to give the finished roofing membrane additional strength in high wind uplift.

The construction of the fabric 12 is commonly referred to as a tri-directional scrim fabric made on a tri-directional scrim machine with 200-2000 denier fill yarn wound around a 200-2000 denier selvage yarn. It is also contemplated that a bi-directional adhesively bound scrim fabric may be used for this purpose as well. Preferably, the fill yarn is about 1000 denier, and the selvage yarn is about 1000 denier. The desired denier may be achieved by bundling a plurality of smaller denier yarns. The preferred range of fabric construction is between about 8×2×2 and 10×5×5, and is most preferably 9×4×4 in a central portion thereof, which means that there are 9 ends/inch in the warp direction and 4 ends/inch on the upward diagonal slope in the fill direction, and 4 ends/inch on the downward diagonal slope in the fill direction. Thus, the total fill yarns are 8 ends/inch.

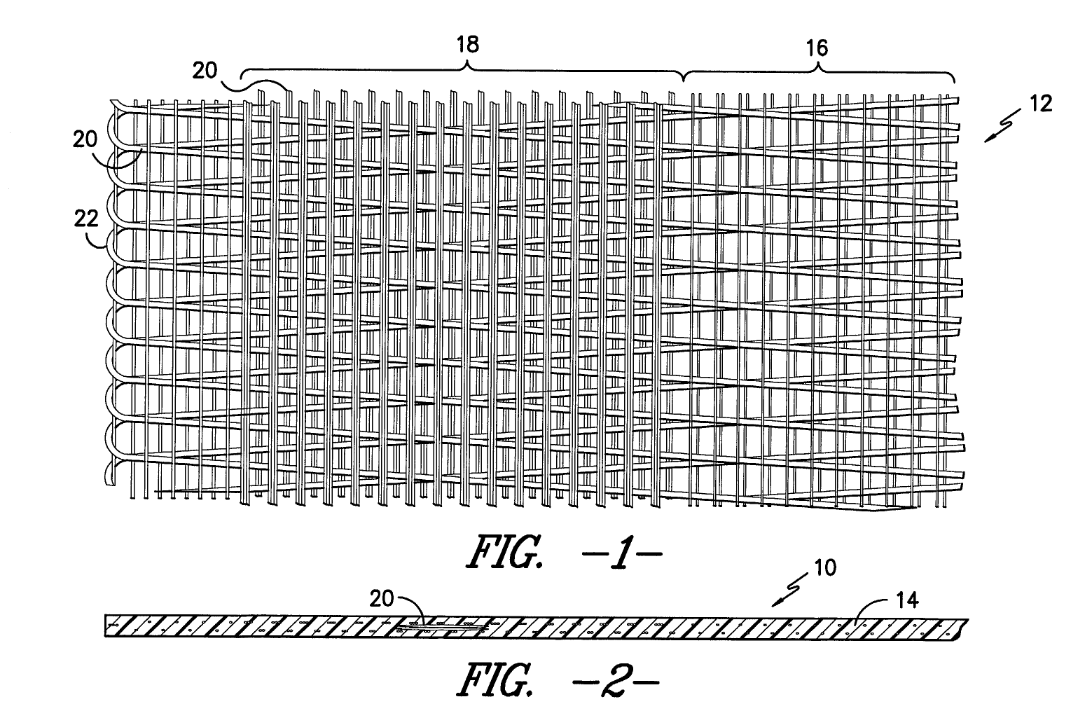

To strengthen the selvage area 18 of the roofing fabric adjacent the outer edges thereof where the roofing connectors or nails will be driven therethrough to secure the fabric to the sub-roofing, the construction of the fabric has been enhanced, as shown in FIG. 1. Preferably, the selvage area 18 occupies a strip about 3.5 inches wide along each longitudinal side of the fabric 12, as shown in FIG. 1. The overall warp ends per inch within the selvage area, in a preferred embodiment, equal roughly 1.5 to 3 times the warp ends in the central portion thereof, as shown in FIG. 2, although even more warp ends per inch may be used for additional strength, if desired. As can be seen, the selvage area has the largest number of yarns therein because it is the area of impact when the fabric is attached to the sub-roofing by the fastening means. Because the yarn has higher density in the selvage area, a greater number of yarns will be secured under the head of the roofing tack or screw, or other fastening means, thus providing increased strength and securement to a roof.

The fabric substrate with reinforced selvages is heat-set using temperatures from 290° F. to 375° F. This temperature range is used to cure the adhesive used in making the fabric. During the cure of the adhesive, the fabric becomes more stabilized from processing temperature, thus reducing the shrinkage that can occur during the membrane manufacturing process. Because the amount of shrinkage is reduced, a fabric with less width can be used in the membrane manufacturing process, thereby reducing the total amount of raw material necessary to manufacture the roofing membrane.

As described above, it can be readily seen that the increased number of selvage yarns in the selvage area, combined with the un-cut, continuous fill yarns forming loops along the edges of the selvage area, provides additional strength to the roofing fabric without reducing the flexibility thereof when laying it down on a flat roof. Further, this increased number of uncut, continuous yarns in the selvage area where the fabric is tacked down on sub-roofing reduces the possibility of tearing or ripping when being installed or upon the application of high winds during a wind or rainstorm. In the optimal arrangement, the additional reinforcing selvage yarns are placed and positioned into the roofing membrane so that the roofing attachments (roofing screws, etc.) are placed within the reinforced selvage areas. As different manufacturers provide different specifications for the placement of the attachments within a roofing membrane, the reinforcement portions of the selvage in the present invention should correspond with such individual specifications.

In light of the above disclosure of potentially preferred embodiments and processes, it will be appreciated that the general principal of invention disclosed herein may be applied in a variety of ways. Therefore, it is contemplated by the appended claims to cover any such modifications and other embodiment as incorporate the features of this invention within the broadest allowable scope thereof.

What is claimed is:

1. A roofing fabric, said fabric comprising:
continuous yarns arranged in a laid scrim to form a substrate, said substrate having a central area and selvage areas along opposed edges thereof;
said selvage areas including loops along outside edges thereof formed by said continuous yarns; and
an adhesive for bonding the continuous yarns together to form said substrate.

2. The structure set forth in claim 1, wherein said selvage areas are reinforced with additional continuous yarns, so that said selvage areas include more yarns than said central area.

3. The structure set forth in claim 1, wherein said adhesive is selected from the group consisting of: polyvinyl alcohol, polyvinyl acetate, styrene butadiene rubber, polyvinyl chloride, polyvinylidene chloride, plastisol, polyacrylate, acrylic latex, and any combinations thereof.

4. The structure set forth in claim 1, wherein said continuous yarns are selected from the group consisting of: aramid, glass, polyester, polyamides, polyolefin, ceramic, basalt, and any combinations thereof.

5. The structure set forth in claim 1, wherein said substrate comprises a tri-directional non-woven scrim.

6. A composite waterproofing roofing membrane comprising:
a fabric comprising continuous yarns forming a substrate, said substrate having a central area and selvage areas along opposed edges thereof;
said selvage areas including loops along outside edges thereof formed by said continuous yarns;
an adhesive for bonding the continuous yarns together to form said substrate; and
a polymeric material encapsulating said fabric.

7. The structure set forth in claim 6, wherein said polymeric material is selected from the group consisting of EPDM, TPO, PVC, chlorinated sulfonated polyethylene, and any combinations thereof.

8. The structure set forth in claim 6, wherein said selvage areas are reinforced with additional continuous yarns, so that said selvage areas include more yarns than said central area.

9. The structure set forth in claim 6, wherein said substrate comprises a tri-directional non-woven laid scrim.

10. The structure set forth in claim 6, wherein said adhesive is selected from the group consisting of: polyvinyl alcohol, polyvinyl acetate, styrene butadiene rubber, polyvinyl chloride, polyvinylidene chloride, plastisol, polyacrylate, acrylic latex, and any combinations thereof.

11. The structure set forth in claim 6, wherein said continuous yarns are selected from the group consisting of: aramid, glass, polyester, polyamides, polyolefins, ceramics, basalts, and any combinations thereof.

12. A roofing membrane comprising:
a fabric comprising continuous yarns forming a substrate, said substrate having warp yarns and weft yarns; and
a polymeric material encapsulating said substrate, wherein said polymeric material is selected from the group consisting of thermoplastic olefin, ethylenepropylenediene terapolymer, or TPE, and any combination thereof.

13. The roofing membrane set forth in claim 12, wherein said substrate includes a central portion and selvage portions, and wherein said selvage portions include additional warp yarns for reinforcement.

14. The roofing membrane set forth in claim 12 or 13, wherein said substrate includes continuous weft yarns that form uncut loops on longitudinal edges thereof.

15. The roofing membrane set forth in claim 13, wherein said selvage portion of said substrate includes aramid yarns.

16. The roofing membrane set forth in claim 12, wherein said substrate is a scrim substrate.

17. The roofing membrane set forth in claim 16, wherein said scrim substrate is a tri-directional laid scrim.

18. The roofing membrane set forth in claim 16, wherein said warp and weft yarns of said scrim substrate are secured together using an adhesive chosen from the group consisting of: polyvinyl alcohol, polyvinyl acetate, styrene butadiene rubber, polyvinyl chloride, polyvinylidene chloride, plastisol, polyacrylate, acrylic latex, and any combinations thereof.

19. The structure set forth in claim 12, wherein said warp and weft yarns are selected from the group consisting of: aramid, glass, polyester, polyamides, polyolefin, ceramic, basalt, and any combinations thereof.

20. A method for manufacturing a composite roofing membrane, said method comprising the steps of:
providing a base fabric having continuous yarns;
adhering yarns of said base fabric together with an adhesive; and
encapsulating said base fabric with a polymeric material chosen from the group consisting of EPDM, TPO, TPE, or any combination thereof.

21. The method set forth in claim 20, wherein said base fabric has a central portion and selvage portions, and wherein said selvage portions include more yarns than the central portion for reinforcement.

22. The method set forth in claim 20, wherein said base fabric is a tri-directional laid scrim fabric.

23. The method set forth in claim 20, wherein said base fabric includes continuous weft yarns and continuous warp yarns.

24. The method set forth in claim 23, wherein said continuous yarns are selected from the group consisting of: aramid, glass, polyester, polyamides, polyolefins, ceramics, basalts, and any combinations thereof.

25. The method set forth in claim 20, wherein said adhesive is selected from the group consisting of: polyvinyl alcohol, polyvinyl acetate, styrene butadiene rubber, polyvinyl chloride, polyvinylidene chloride, plastisol, polyacrylate, acrylic latex, and any combinations thereof.

26. A composite waterproofing roofing membrane comprising:
a fabric comprising continuous yarns forming a substrate, said substrate having a central area and selvage areas along opposed edges thereof;
an adhesive for bonding the continuous yarns together to form said substrate; and
a polymeric material encapsulating said fabric;
wherein said roofing membrane achieves a rating of at least I-75 when tested using fasteners at 12 inch intervals according to FMRC (Factory Mutual Research Corporation) 12×24 Uplift Pressure Test Procedure number 4470.

27. The structure set forth in claim 26, wherein said polymeric material is EPDM.

28. The structure set forth in claim 26, wherein said selvage areas are reinforced with additional continuous yarns, so that said selvage areas include more yarns than said central area.

29. The structure set forth in claim 26, wherein said substrate comprises a tri-directional non-woven laid scrim.

30. The structure set forth in claim 26, wherein said adhesive is selected from the group consisting of: polyvinyl alcohol, polyvinyl acetate, styrene butadiene rubber, polyvinyl chloride, polyvinylidene chloride, plastisol, polyacrylate, acrylic latex, and any combinations thereof.

31. The structure set forth in claim 26, wherein said continuous yarns are selected from the group consisting of: aramid, glass, polyester, polyamides, polyolefins, ceramics, basalts, and any combinations thereof.

32. A composite waterproofing roofing membrane comprising:
a fabric comprising continuous yarns forming a substrate, said substrate having a central area and selvage areas along opposed edges thereof;
an adhesive for bonding the continuous yarns together to form said substrate; and
a polymeric material encapsulating said fabric;
wherein said roofing membrane achieves a rating of at least I-135 when tested using fasteners at 6 inch intervals according to FMRC (Factory Mutual Research Corporation) 12×24 Uplift Pressure Test Procedure number 4470.

33. The structure set forth in claim 32, wherein said polymeric material is EPDM.

34. The structure set forth in claim 32, wherein said selvage areas are reinforced with additional continuous yarns, so that said selvage areas include more yarns than said central area.

35. The structure set forth in claim 32, wherein said substrate comprises a tri-directional non-woven laid scrim.

36. The structure set forth in claim 32, wherein said adhesive is selected from the group consisting of: polyvinyl alcohol, polyvinyl acetate, styrene butadiene rubber, polyvinyl chloride, polyvinylidene chloride, plastisol, polyacrylate, acrylic latex, and any combinations thereof.

37. The structure set forth in claim 32, wherein said continuous yarns are selected from the group consisting of: aramid, glass, polyester, polyamides, polyolefins, ceramics, basalts, and any combinations thereof.
